(19) United States
(12) Patent Application Publication
(10) Pub. No.: US 2011/0299135 A1
(43) Pub. Date: Dec. 8, 2011

(54) OVERHEAD IMAGE READING APPARATUS

(75) Inventor: Masanari TAKABATAKE, Ishikawa (JP)

(73) Assignee: PFU LIMITED

(21) Appl. No.: 13/111,498

(22) Filed: May 19, 2011

(30) Foreign Application Priority Data
Jun. 2, 2010 (JP) 2010-127238

(51) Int. Cl. H04N 1/04

(52) U.S. Cl. 358/474

(57) ABSTRACT

The overhead image reading apparatus includes a line sensor 20 which has light receiving elements arranged one-dimensionally to read the image of a document 75 in a one-dimensional direction, a white LED 26 which emits light, a collimator lens 28 which converts light emitted from the white LED to straight-line light, a diffuser plate 29 which converts light converted to straight-line light by the collimator lens to linear irradiation light 90, and line light source units 25 which irradiate linear irradiation light onto a reading region of an image by the line sensor. Moreover, the apparatus includes a rotary head section 5 which holds the line sensor and the line light source units as a single body and rotates the line sensor and the line light source units as a single body when the line sensor reads the image.

### CROSS-REFERENCE TO RELATED APPLICATION

The present application claims priority to and incorporates by reference the entire contents of Japanese Patent Application No. 2010-127238 filed in Japan on Jun. 2, 2010.

### BACKGROUND OF THE INVENTION

1. Field of the Invention

The present invention relates to an overhead image reading apparatus.

2. Description of the Related Art

Various types of image reading apparatuses are heretofore known in which an image of a document is read and processing is electrically performed. Of these reading apparatuses, the so-called overhead image reading apparatus is known in which a document is placed on a platen, and light is cast on the document from above a reading surface of the document to read an image, which increases easiness at the time of reading.

For example, Japanese Patent No. 2860119 describes an imaging apparatus in which a pedestal with a bendable support standing upright is placed on a placing surface on which an object to be imaged is placed, and a camera which obtains an image of the object is provided in the support provided upright on the pedestal. Thus, an image of the object placed on the pedestal can be obtained by the camera from above, and at the time of imaging, the imaging range can be changed by bending the support.

Japanese Patent No. 2982614 describes an image scanner in which an illumination device and an image reading unit having an image sensor, a lens, and a reflecting mirror are attached to a document platen by a stand arm which holds the image reading unit in a movable state. Thus, the image of a document on the document platen can be read by the image reading unit from above the document, and when the image reading unit is unused, the image reading unit is moved, leading to expanding the space on the document platen.

Japanese Patent No. 3027915 describes an image scanner in which a reading unit having a one-dimensional image sensor, a lens, a reflecting mirror, and a two-dimensional image sensor is held by an arm attached to a platen, and a display device is provided to display at least an image read by the two-dimensional image sensor. Thus, the image of the document is read more appropriately by the one-dimensional image sensor from above the document on the basis of the image read by the two-dimensional image sensor and displayed on the display device.

Japanese Patent No. 3931107 describes a non-contact image reading apparatus that includes a support for supporting a camera which reads an image, and a platen movable in a horizontal direction. Thus, by moving the platen, the image of a document is obtained by the camera from the above for a predetermined range, and a plurality of captured images are combined. In this way, it is possible to obtain the image of the document of a large size.

When an image of the document is taken from above the reading surface of the document, it is preferable that the image of the document is taken from directly above the document from the viewpoint of image quality. When the image of the document is obtained from directly above the document, a read portion of an image is inevitably located above around the center of the document. Usually, as a lens provided in the reading portion of the image is distant from an optical axis as the center in an angle of view, the quantity of light to be received by the lens is lowered. For this reason, in order to reduce the difference in the quantity of light between the optical axis portion and the end portion of the angle of view, it is preferable to reduce the angle of view. The angle of view can be reduced by increasing the distance between the lens and the document, that is, the distance between the read portion of the image and the document.

However, when the read portion is located above around the center of the document or when the distance between the read portion of the image and the document increases so as to reduce the angle of view, the entire apparatus may be large in size. When the apparatus is large in size, installability or operability may be degraded, and the appearance may be damaged. In particular, since it is assumed that the overhead image reading apparatus is used in a general office or at home, there is an increasing demand for improving installability.

### SUMMARY OF THE INVENTION

It is an object of the present invention to at least partially solve the problems in the conventional technology.

The present invention is directed to an overhead image reading apparatus. The overhead image reading apparatus includes an image reading unit which has light receiving elements arranged one-dimensionally to read an image of a document in a one-dimensional direction; and a plurality of light source units. Each of light source units has a point-like light source emitting light and a linear light irradiation unit converting light emitted from the point-like light source to linear irradiation light, and irradiates the linear irradiation light on a reading region of an image by the image reading unit. Moreover, the overhead image reading apparatus includes a rotary unit section which holds the image reading unit and the light source unit as a single body, and rotates the image reading unit and the light source unit as a single body when the image reading unit reads the image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an overhead image reading apparatus according to an embodiment;

FIG. 2 is a sectional view of a main part of a rotary head shown in FIG. 1;

FIG. 3 is a sectional view of a line light source unit shown in FIG. 2;

FIG. 4 is an explanatory view illustrating the outline of the configuration of the overhead image reading apparatus shown in FIG. 1;

FIG. 5 is an explanatory view illustrating a case where an image of a document is read;

FIG. 6 is an explanatory view illustrating the relationship between an angle from the optical axis of a lens and a light quantity ratio;

FIG. 7 is an explanatory view illustrating the light quantity distribution of light which is irradiated from a line light source unit;

FIG. 8 is an explanatory view illustrating the relationship between a scanning plane by a line sensor and linear irradiation light by a line light source unit;

FIG. 9 is a sectional view taken along the line A-A of FIG. 8;

FIG. 10 is an explanatory view illustrating supplement of light reception in a line sensor;

FIG. 11 is a comparison diagram of the overhead image reading apparatus shown in FIG. 1 and an example of an overhead image reading apparatus of the prior art;

FIG. 12 is an explanatory view illustrating the light quantity distribution of light which is irradiated from a line light source unit in an overhead image reading apparatus according to a modification;

FIG. 13 is an explanatory view illustrating the relationship between linear irradiation light by a line light source unit and a scanning plane by a line sensor shown in FIG. 12; and

FIG. 14 is a sectional view of a line light source unit in an overhead image reading apparatus according to a modification.

### DETAILED DESCRIPTION OF THE PREFERRED EMBODIMENTS

Hereinafter, an embodiment of an overhead image reading apparatus according to the invention will be described in detail with reference to the drawings. It should be noted that the embodiment is not intended to limit the invention. The constituent elements in the following embodiment include those which are replaceable or easily replaced by those skilled in the art or those substantially identical.

### Embodiment

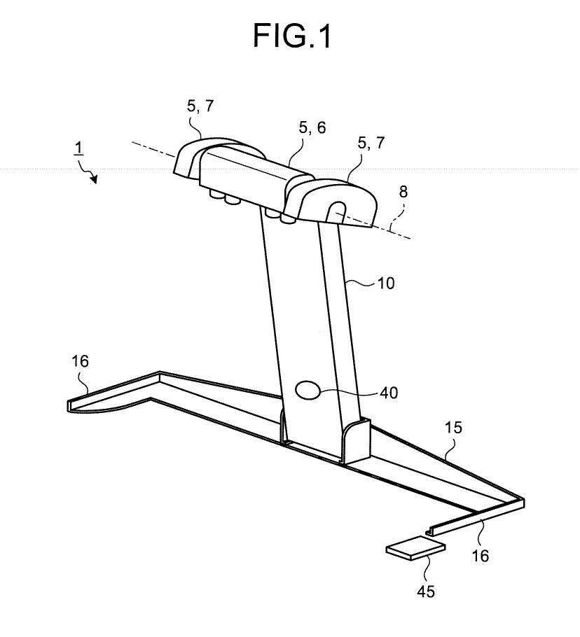

FIG. 1 is a perspective view of an overhead image reading apparatus according to an embodiment. The overhead image reading apparatus 1 shown in FIG. 1 has a base 15 which is a base portion serving as a leg portion when the overhead image reading apparatus 1 is placed in an arbitrary portion, an arm 10 which has one end connected to the base 15, and a rotary head section 5 which is provided on one side of the arm 10, i.e., the opposite to the other side of the arm 10 connected to the base 15, has a rotary head 6 and head support portions 7, and serves as a rotary unit in which the rotary head 6 is rotatably supported by the head support portions 7.

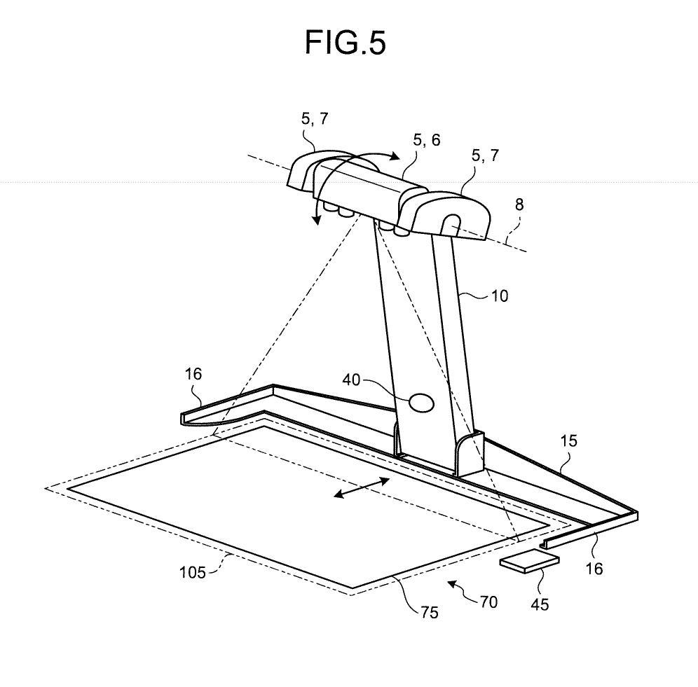

Of these, the base 15 is formed in a U shape, and portions which are provided at both ends of a central straight-line portion in the U shape and which are connected to the straight-line portion perpendicular to the straight-line portion form guide portions 16. The guide portions 16 are provided to stably install the overhead image reading apparatus 1 and to serve as a measure of a placing position when a document 75 is placed in reading the image of the document 75 (see FIG. 5). That is, the base 15 is provided with the two guide portions 16, and the interval between the two guide portions 16 substantially indicates a reading width when the overhead image reading apparatus 1 reads the image of the document 75. The arm 10 is connected to a central portion of the base 15 between the guide portions 16 and is provided upward from the base 15 in a normal use form of the overhead image reading apparatus 1.

The rotary head section 5 is connected to one side of the arm 10, the other side of which is connected to the base 15. Specifically, the rotary head section 5 is connected to the arm 10 by connecting the head support portions 7 to the end portion on the one side of the arm 10, and is supported by the arm 10. The rotary head 6 of the rotary head section 5 supported by the arm 10 is supported by the head support portions 7 to be rotatable with respect to the head support portion 7. Specifically, the two head support portions 7 are provided to be separated from each other in the direction between the guide portions 16 of the base 15 and to protrude in the same direction as the direction in which the guide portions 16 protrude with respect to the portion of the base 15 to which the arm 10 is connected.

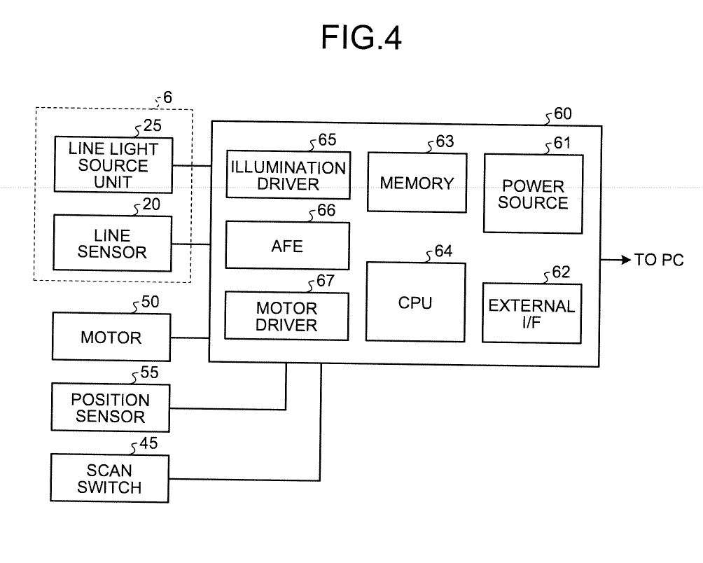

The head support portions 7 are internally provided with a motor 50 which is rotatable at an arbitrary rotation angle (see FIG. 4). The rotary head 6 is provided between the two head support portions 7 provided in the above-described manner, and is supported by the head support portions 7 to be rotatable by the motors 50 around a rotation axis 8 extending in the direction between the two head support portions 7.

The guide portions 16 of the base 15 are formed to protrude in the direction perpendicular to the rotation axis 8 extending in the direction between the two head support portions 7.

The arm 10 is provided with a human detection sensor 40 which makes a response if the hand of the human being approaches. As the human detection sensor 40, for example, an infrared sensor which uses an infrared ray and detects an infrared ray reflected by the hand of the human being to detect that the hand of the human being approaches, a capacitive proximity sensor, or the like is used. A scan switch 45, which serves as start instruction means for instructing to start reading when the overhead image reading apparatus 1 of this embodiment reads the image of the document 75, is provided around the base 15.

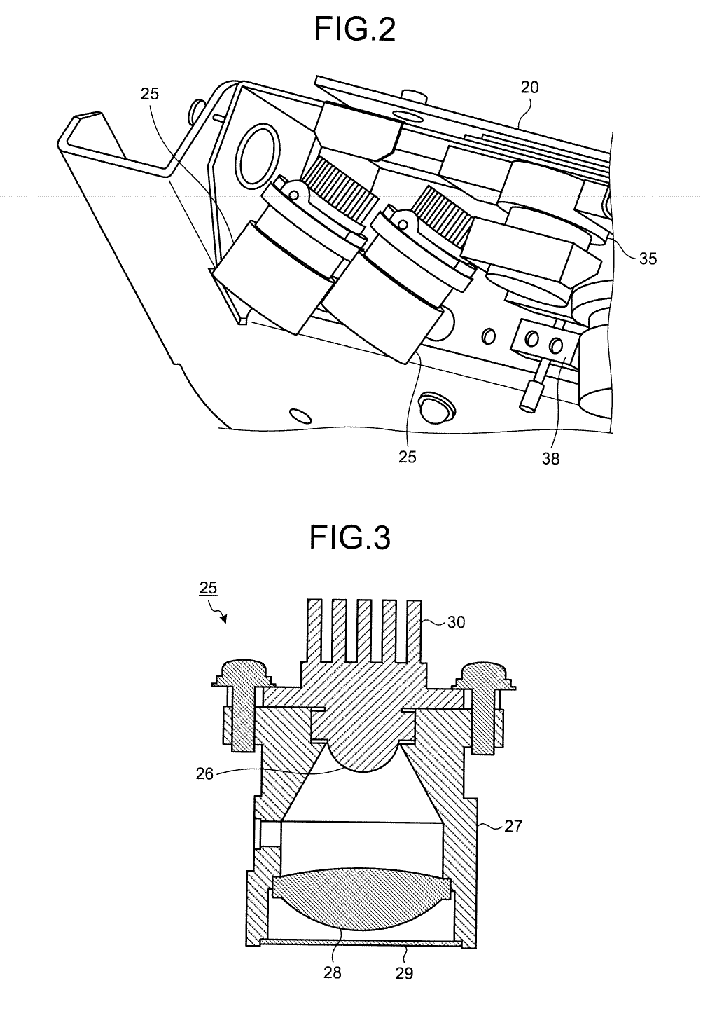

FIG. 2 is a sectional view of a main part of a rotary head 6 shown in FIG. 1. The rotary head 6, which is supported by the head support portions 7, has a line sensor 20 which serves as an image reading unit having a plurality of light receiving elements (not shown) to read the image of the document 75, and line light source units (also called “straight-line light source units”) 25 which serve as a light source unit configured to irradiate light onto the reading region of the image by the line sensor 20. Of these, the light receiving elements of the line sensor 20 are arranged in a one-dimensional array in the direction parallel to the rotation axis 8, and are provided as a light receiving unit which converts light received to an electrical signal. In this way, a plurality of light receiving elements are arranged in a one-dimensional array, the line sensor 20 can read the image of the document 75 in a one-dimensional direction parallel to the rotation axis 8.

As described above, in the rotary head section 5 in which the line sensor 20 and the line light source units 25 are provided in the rotary head 6, the rotary head 6 is rotatably supported by the head support portions 7 connected to the arm 10. Thus, the line sensor 20 and the line light source units 25 are supported to be relatively rotatable around the rotation axis 8 parallel to the array direction of the light receiving elements with respect to the arm 10.

The light receiving elements of the line sensor 20 include a light receiving element which can detect a red light component, a light receiving element which can detect a green light component, and a light receiving element which can detect a blue light component. The signals of light detected by each of the light receiving elements are combined with each other, which enables a color image to be read.

The rotary head 6 has a lens 35 which condenses light from the direction of the document 75 on the line sensor 20, and a focus mechanism 38 which adjusts a focus when light is condensed on the line sensor 20 by the lens 35. Of these, the focus mechanism 38 has an actuator, such as a piezoelectric motor or a voice coil motor, such that the lens 35 can be moved in the direction of the line sensor 20 by the actuator. The focus mechanism 38 moves the lens 35 by the actuator to adjust the distance between the lens 35 and the line sensor 20 and to adjust the position of the focus, such that light from the direction of the document 75 can be focused on the line sensor 20 by the lens 35.

A plurality of line light source units 25 are provided in the rotary head 6. The line light source units 25 are arranged on both sides of the lens 35 in the direction of the interval between the two head support portions 7.

FIG. 3 is a sectional view of a line light source units shown in FIG. 2. The line light source units 25 of the rotary head 6 will be described in detail. Each of the line light source units 25 has a white LED (Light Emitting Diode) 26 which serves as a point-like light source to emit light, a collimator lens 28 which serves as a straight-line light forming unit to convert light emitted from the white LED 26 to straight-line light, a diffuser plate 29 which serves as a linear light forming unit to linearize light converted to straight-line light by the collimator lens 28 in the direction parallel to the rotation axis 8, and to obtain linear irradiation light, a radiator plate 30 which radiates heat generated from the white LED 26, and a holder 27 which holds the white LED 26, the collimator lens 28, the diffuser plate 29, the radiator plate 30, and the like. The point-like light source described herein refers to a light source, such as a general LED, in which light is irradiated from a point-like luminous material, not a light source, such as a linear fluorescent lamp, in which light is irradiated from a linear luminous material.

Of the respective elements of the line light source units 25, the collimator lens 28 is arranged in the traveling direction of light when the white LED 26 emits light, and the diffuser plate 29 is arranged in the traveling direction of straight-line light when light from the white LED 26 is converted to straight-line light by the collimator lens 28. Thus, the collimator lens 28 and the diffuser plate 29 serve as a linear light irradiation unit which converts light emitted from the white LED 26 to linear irradiation light. The radiator plate 30 is arranged opposite to the light emitting portion of the white LED 26 and outside of the line light source units 25.

The diffuser plate 29 converts light from the white LED 26 having been converted to straight-line light by the collimator lens 28 to linear irradiation light in the direction parallel to the rotation axis 8, that is, in the direction parallel to the reading direction when the image of the document 75 is read by the line sensor 20 in the one-directional direction, and linearly irradiates the light onto the reading region of the image by the line sensor 20. In the circumferential direction around the rotation axis 8, the irradiation direction of light from the line light source units 25 is substantially the same as the reading direction of the image of the document by the line sensor 20.

FIG. 4 is an explanatory view illustrating the outline of the configuration of the overhead image reading apparatus shown in FIG. 1. The overhead image reading apparatus 1 provided in the above-described manner has a control unit 60 which performs overall control of the overhead image reading apparatus 1, and the control section 60 is internally provided in the arm 10. Connected to the control section 60 are the line sensor 20 and the line light source units 25 provided in the rotary head 6, and the motor 50 which rotates the rotary head 6. Also connected to the control section 60 are the scan switch 45 which instructs to start reading and a position sensor 55 which is used for positioning when RGB signals are detected by the light receiving elements of three colors (RGB) in the line sensor 20 and combined with each other is. An external apparatus, such as a PC (personal computer), which outputs and inputs signals to and from the overhead image reading apparatus 1 is also connected to the control section 60.

The control unit 60 to which the respective elements are connected has a power source 61 which transforms electricity introduced from the outside to power for use in the respective electrical components of the overhead image reading apparatus 1, an external I/F (Interface) 62 which is a connection portion to the external apparatus in carrying out input/output of signals between the respective elements of the overhead image reading apparatus 1 and the external apparatus, a memory 63 serving as a main storage device, a CPU (Central Processing Unit) 64 which performs various arithmetic operations, an illumination driver 65 which performs control of light emission in the line light source units 25, an analog front-end circuit (AFE) 66 which carries out gain adjustment or offset adjustment of an analog signal of light detected by the line sensor 20, and a motor driver 67 which adjusts rotation of the motors 50 rotating the rotary head 6.

The overhead image reading apparatus 1 of this embodiment is configured as above, and the actions thereof will be hereinafter described. FIG. 5 is an explanatory view illustrating a case where the image of the document is read. The overhead image reading apparatus 1 of this embodiment is used while being placed on, for example, a desk or the like. In reading the image of the document 75, a portion where the overhead image reading apparatus 1 is placed is referred to as a placing surface 70, and the image of the document 75 is read in a state where the document 75 is placed on the placing surface 70.

When the overhead image reading apparatus 1 is placed on the placing surface 70, one surface of the base 15, the other face of which is connected to the arm 10, is arranged to face the placing surface 70, and the one surface of the base 15 is placed to be in contact with the placing surface 70. In this way, the base 15 is placed on the placing surface 70, such that the arm 10 connected to the base 15 is fixed to the placing surface 70. At this time, the rotary head section 5 supported by the arm 10 is maintained at a predetermined distance from the placing surface 70. For this reason, the line sensor 20 or the line light source units 25 held in the rotary head 6 of the rotary head section 5 is maintained at a predetermined distance from the placing surface 70.

When the document 75 is placed on the placing surface 70 in order to read the image of the document 75 by the overhead image reading apparatus 1, the document 75 is placed on the side of the base 15 on which the guide portions 16 protrude. In this case, when the document 75 is formed, for example, in a rectangular shape, it is preferable to place the document 75 such that, in a state where at least a part of the document 75 is located between the two guide portions 16, a pair of parallel sides from among four sides becomes parallel to the direction in which the guide portions 16 are formed.

In reading the image of the document 75, the image is read in a state where the document 75 is placed on the placing surface 70 in the above-described manner. Meanwhile, if the document 75 is placed around the base 15, the human detection sensor 40 detects that the hand of a user has approached. When this detection has been done, the control section 60 determines that the document 75 will be read, and carries out preparation for starting reading, for example, starting the supply of electricity to the respective elements.

Actually, in starting the reading of the image of the document 75, the user carries out an input operation on the scan switch 45 to start the reading of the document 75. When the user carries out an input operation on the scan switch 45, the input to start the reading is transmitted to the control unit 60. The control unit 60 to which a signal to start the reading is transmitted from the scan switch 45 activates the respective components necessary for reading the image of the document 75. Specifically, the line light source unit 25 is controlled by the illumination driver 65 to turn on the line light source units 25, and light from the document 75 detected by the light receiving elements of the line sensor 20 is adjusted by the AFE 66.

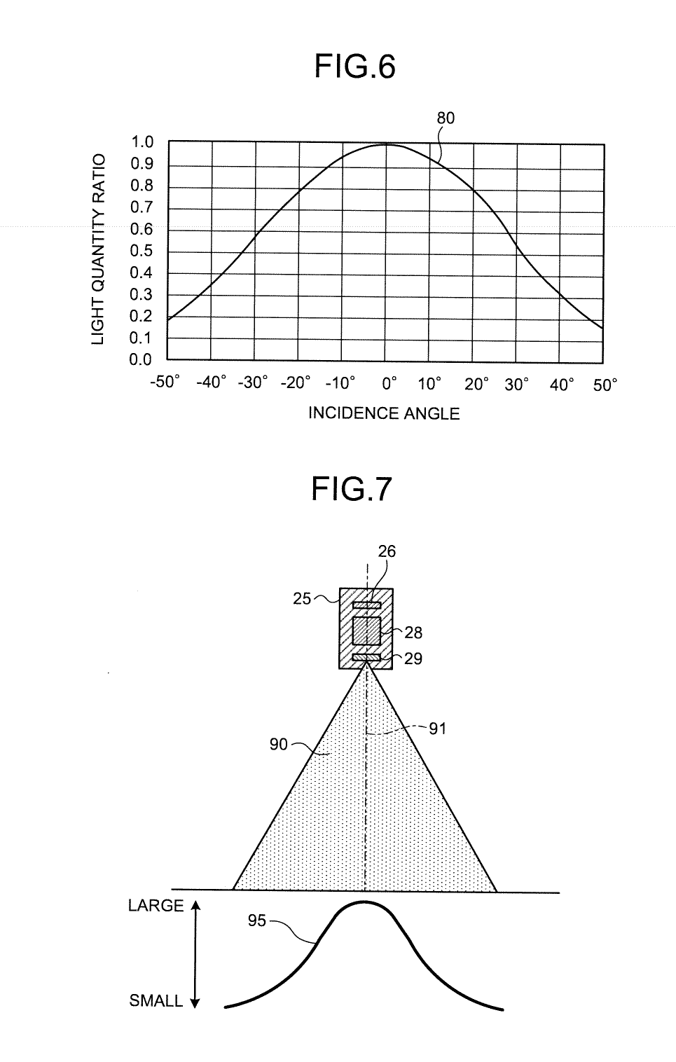

FIG. 6 is an explanatory view illustrating the relationship between an angle from the optical axis of a lens and a light quantity ratio. Here, when light from the document 75 is received by the line sensor 20, light having passed through the lens 35 is received. Meanwhile, the quantity of the light having passed through the lens 35 differs, depending on an angle when the light passes through the lens 35. That is, when light passes through the lens 35, the quantity of light passing through the lens 35 decreases with an increase in the angle with respect to the optical axis of the lens 35. Specifically, the quantity of light when light passes through the lens 35 is in proportion to the fourth power of cosine of an incidence angle of light with respect to the optical axis (fourth-power-of-cosine rule). Thus, the larger the incidence angle, the smaller the quantity of light passing through the lens 35. That is, as shown in FIG. 6, on an assumption that, when the incidence angle with respect to the optical axis is 0°, the quantity of light passing through the lens 35 is 1.0, the light quantity ratio decreases as the incidence angle is distant from 0°.

As described above, the light quantity ratio decreases as the incidence angle is distant from 0°, which is the incidence angle on the optical axis. Meanwhile, the incidence angle increases as light passing through the lens 35 moves from a position distant from the optical axis toward the lens 35. For this reason, ambient light, which is light from a portion comparatively distant from the optical axis from among light toward the lens 35, has a small light quantity ratio. Thus, the quantity of ambient light when light passes through the lens 35 is lowered. As described above, while the quantity of light when light passes through the lens 35 has a small light quantity ratio with an increasing distance from the optical axis of the lens 35, light having passed through the lens 35 is received by the line sensor 20. For this reason, the light quantity ratio of light passing through the lens 35 to the incidence angle of light on the lens 35 is shown by a light reception quantity distribution 80 of light received by the line sensor 20.

FIG. 7 is an explanatory view illustrating the light quantity distribution of light which is irradiated from the line light source units. When the line sensor 20 receives light, the above-described light reception quantity distribution 80 applies, depending on the characteristic of the lens 35. Meanwhile, even when light is irradiated from the line light source units 25, light is irradiated in a state where the quantity of light differs depending on the irradiation position. Description will be provided as to a light quantity distribution 95 when light is irradiated from the line light source units 25. First, when light is irradiated from the line light source units 25, the white LED 26 as a light source emits light. Light emitted from the white LED 26 passes through the collimator lens 28 and travels toward the diffuser plate 29. At this time, light is converted to straight-line light by the collimator lens 28 and travels toward the diffuser plate 29. Straight-line light from the collimator lens 28 is diffused as passing through the diffuser plate 29, is converted to linear irradiation light 90, which passes through the diffuser plate 29. Linear irradiation light 90 is irradiated outside as light emitted from the line light source units 25.

Light irradiated from the line light source units 25 is converted to linear irradiation light 90 and irradiated. Meanwhile, the quantity of linear irradiation light 90 is not made uniform and differs depending on a position where light is irradiated. Specifically, when the direction of straight-line light generated by the collimator lens 28 is assumed to be an optical axis 91, the quantity of linear irradiation light 90 becomes largest in the portion of the optical axis 91. The quantity of linear irradiation light 90 is reduced with an increasing distance from the optical axis 91. For this reason, the light quantity distribution 95 of light converted to linear irradiation light 90 and irradiated from the line light source units 25 is such that the quantity of light is largest around the optical axis 91 and decreases with an increasing distance from the optical axis 91.

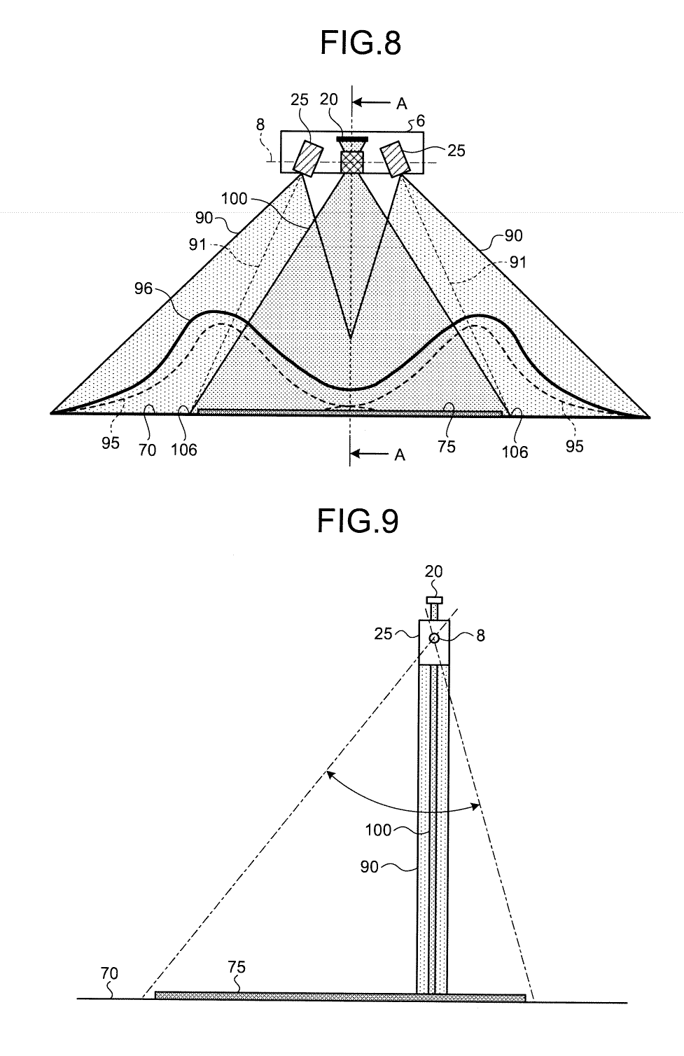

FIG. 8 is an explanatory view illustrating the relationship between a scanning plane by the line sensor and linear irradiation light by the line light source units. FIG. 9 is a sectional view taken along the line A-A of FIG. 8. The overhead image reading apparatus 1 of this embodiment includes four line light source units 25 in total with two on each side of the line sensor 20. However, in FIG. 8 and the following description, for simplification of the description of the key point, two line light source units 25 are provided in total with one on each side of the line sensor 20. In reading the image of the document 75 by the line sensor 20 in the above-described light reception quantity distribution 80, when light is irradiated from the line light source units 25 in the above-described light quantity distribution 95, linear irradiation light 90 is irradiated such that the optical axis 91 of the line light source units 25, that is, the optical axis 91 of the collimator lens 28 is directed toward reading region end portions 106 which are the end portions of the reading region of the image by the line sensor 20.

In reading an image, the line sensor 20 reads an image in a one-dimensional direction. For this reason, the reading range of an image by the line sensor 20 is defined by a scanning plane 100 which is comprised of the direction of the distance from the line sensor 20 or the direction of the distance from the lens 35 as the incoming portion of light to be read by the line sensor 20 and the one-dimensional reading direction by the line sensor 20. When an image is read by the line sensor 20, an image within the scanning plane 100 is read, and the line sensor 20 is maintained at a predetermined distance from the placing surface 70.

Thus, a reading region 105 (see FIG. 5) when an image is read by the line sensor 20 is a portion where the scanning plane 100 and the placing surface 70 cross each other. The reading region end portions 106 are the end portions in the one-dimensional direction of the reading region 105 when an image is read by the line sensor 20. When light is irradiated from the line light source units 25, linear irradiation light 90 is irradiated such that the optical axis 91 is directed toward the reading region end portions 106. The plurality of line light source units 25 is provided, and each of the line light source units 25 irradiates linear irradiation light 90 such that the optical axis 91 is directed toward the near reading region end portion 106 from among the reading region end portions 106 at both ends in the one-dimensional direction when an image is read by the line sensor 20.

As described above, the linear irradiation light 90, which is irradiated from the line light source units 25, is irradiated as irradiation light linearized in the direction parallel to the rotation axis 8. Meanwhile, the scanning plane 100 when an image is read by the line sensor 20 is a plane which defines a region when the image of the document 75 is read in the one-dimensional direction parallel to the rotation axis 8. For this reason, both the linear irradiation light 90 and the scanning plane 100 are parallel to the rotation axis 8. In other words, the rotation axis 8 is located within the same plane as the scanning plane 100 or linear irradiation light 90.

With regard to the line light source units 25, the irradiation direction of light in the circumferential direction around the rotation axis 8 is substantially the same as the reading direction of the image of the document 75 by the line sensor 20. For this reason, the linear irradiation light 90 and the scanning plane 100 partially overlap each other. The line light source units 25 are arranged on both sides of the lens 35 in the direction of the interval between the two head support portions 7, that is, in the direction of the rotation axis 8, such that the linear irradiation light 90 overlaps the scanning plane 100 from both sides of the scanning plane 100 in the direction parallel to the rotation axis 8. That is, the line sensor 20 and the line light source units 25 are arranged so as to have portions located at the same positions in the scanning plane 100 and linear irradiation light 90. Thus, when an image of the document 75 is read with the light irradiated from the line light source units 25, an image is read in a state where the scanning plane 100 and linear irradiation light 90 overlap each other in the vicinity of the placing surface 70.

When the image of the document 75 is read by the line sensor 20, an image is read along the scanning plane 100 in the above-described manner. Meanwhile, when the image of the document 75 is read along the scanning plane 100, actually, an image of a portion of the document 75 or the placing surface 70, which the scanning plane 100 crosses, is read. In this case, the scanning plane 100 is a plane defined by the direction of the distance from the lens 35 and the direction of the one-dimensional reading by the line sensor 20, such that a portion in which an image is read at the time of predetermined scanning by the line sensor 20 is in a direction of the one-dimensional reading by the line sensor 20 on the document 75 or the placing surface 70. That is, a portion in which an image is read at the time of scanning by the line sensor 20 is in the direction parallel to the rotation axis 8.

When the linear irradiation light 90 is irradiated from the line light source units 25, light is irradiated onto a portion of the document 75 or the placing surface 70 which the linear irradiation light 90 crosses. The linear irradiation light 90 is irradiated as irradiation light linearized in the direction parallel to the rotation axis 8. For this reason, a portion of the document 75 or the placing surface 70, onto which the linear irradiation light 90 is irradiated, is in the direction of the line of irradiation light linearized by the line light source units 25 on the document 75 or the placing surface 70, that is, in the direction parallel to the rotation axis 8.

The linear irradiation light 90, which is irradiated in a state of being linearized in the direction parallel to the rotation axis 8, is different in the quantity of light depending on a position to be irradiated, and has the light quantity distribution 95 such that the quantity of light is largest in the vicinity of the optical axis 91 and becomes lower with an increasing distance from the optical axis 91.

With regard to the light quantity distribution 95, the linear irradiation light 90 irradiated by each of the line light source units 25 has the same light quantity distribution 95. Meanwhile, the actual quantity of light in the placing surface 70, onto which linear irradiation light 90 is irradiated, is the quantity of light which is obtained by adding linear irradiation light 90 irradiated from the line light source units 25. For this reason, a total light quantity distribution 96, which is an actual light quantity distribution of the linear irradiation light 90 from the line light source units 25 is a distribution which is obtained by adding the light quantity distribution 95 from the respective line light source units 25. That is, for example, the quantity of light increases in a portion where the linear irradiation light 90 overlaps, such that, in the portion, the total light quantity distribution 96 increases compared to the quantity in the light quantity distribution 95 of each of the linear irradiation light 90.

When the image of the document 75 is read by the line sensor 20, as described above, the linear irradiation light 90 from the line light source units 25 is irradiated in the state of the total light quantity distribution 96. Meanwhile, each of the line light source units 25 irradiates the linear irradiation light 90 such that the optical axis 91 is directed toward the reading region end portions 106. The light quantity distribution 95 of each of the line light source units 25 is such that the quantity of light in the vicinity of the optical axis 91 increases. As a result, in the total light quantity distribution 96, the quantity of light in the vicinity of the optical axis 91 increases. For this reason, with regard to irradiation light irradiated onto the reading region 105, the quantity of light increases in the vicinity of the reading region end portions 106 and becomes lower with an increasing distance from the reading region end portions 106.

The linear irradiation light 90, which is irradiated from the line sensor 20 in the total light quantity distribution 96, reaches the placing surface 70 and is reflected by the document 75 placed on the placing surface 70. The reflected light is directed toward the line sensor 20 to pass through the lens 35 and reach the line sensor 20. The light is received by the light receiving elements of the line sensor 20, such that the image of the document 75 is read.

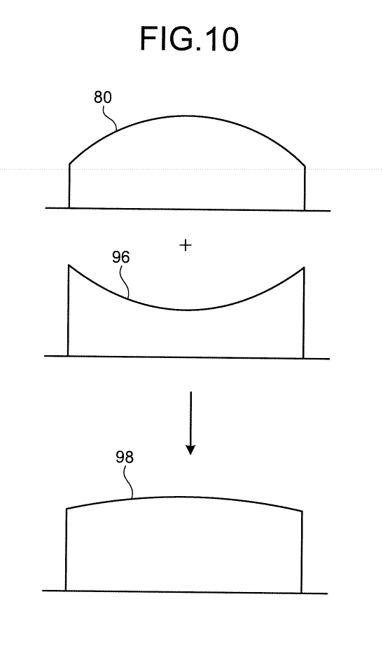

FIG. 10 is an explanatory view illustrating supplement of light reception by the line sensor 20. In this way, in the line sensor 20, the reflected light by the document 75 is received by the light receiving elements, such that the image of the document 75 is read. Meanwhile, the light, which is received by the line sensor 20, is light having passed through the lens 35, such that the light is received in the light reception quantity distribution 80, as described above. That is, the line sensor 20 receives the reflected light from the document 75 in a state where the light quantity ratio decreases with an increasing distance from the optical axis of the lens 35. The line light source units 25 irradiate the linear irradiation light 90 onto the placing surface 70, in which the document 75 is placed, in the total light quantity distribution 96 in which the quantity of light increases in the vicinity of the reading region end portions 106 and decreases with an increasing distance from the reading region end portions 106.

That is, the line sensor 20 receives the reflected light in a state where the quantity of received light is reduced with an increasing distance from the optical axis of the lens 35 toward the reading region end portions 106. Meanwhile, the line light source units 25 irradiate light in a manner where the quantity of light increases with an increasing distance from the optical axis of the lens 35 in the middle between the reading region end portions 106 toward the reading region end portions 106. That is, with regard to the linear irradiation light 90 irradiated onto the document 75, the quantity of light increases with an increasing distance from the optical axis of the lens 35 toward the reading region end portions 106. For this reason, with regard to the reflected light by the document 75, the quantity of light increases with a decreasing distance from the reading region end portions 106.

In contrast, while the quantity of light, which passes through the lens 35, is reduced because of light from a position distant from the optical axis of the lens 35, with regard to the reflected light by the document 75, the quantity of light increases with an increasing distance from the optical axis of the lens 35 and with a decreasing distance from the reading region end portions 106. For this reason, in the distribution of the quantity of light passing through the lens 35 based on the characteristic of the lens 35 and the total light quantity distribution 96, changes in the quantity of light are canceled each other. The reflected light from the document 75 passes through the entire lens 35 with the same quantity of light. Thus, a sensor reaching light quantity 98, which is the quantity of the reflected light, passing through the lens 35 and reaching the line sensor 20 is the same as a whole.

As described above, the line light source units 25 irradiate the linear irradiation light 90 in the total light quantity distribution 96 which supplements the light reception quantity distribution 80 when light is received by the line sensor 20 in reading the image of the document 75. The sensor reaching light quantity 98 reaching the line sensor 20 is the same as a whole. Thus, the line sensor 20 reads the entire reading region 105 under the same condition. That is, the line sensor 20 receives light reflected by the reading region 105, such as reflected light from the document 75 placed on the placing surface 70 under the same condition over the entire reading region 105, and reads the image of the document 75 under the same condition in the entire one-dimensional direction parallel to the rotation axis 8.

When the image of the document 75 is read by the line sensor 20 in the above-described manner, the motor 50 is activated by the motor driver 67 to rotate the rotary head 6 around the rotation axis 8. The rotary head 6 supports the line sensor 20 and the line light source units 25 to be relatively rotatable around the rotation axis 8 with respect to the document 75. In rotating the rotary head 6 in the above-described manner, the rotation axis 8 is parallel to the reading direction of an image by the line sensor 20 held by the rotary head 6 and the direction of the line of an irradiation portion when the linear irradiation light 90 from the line light source units 25 is irradiated onto the placing surface 70. For this reason, when the rotary head 6 is rotated, the reading position of the image in the line sensor 20 held by the rotary head 6 and the irradiation position of the linear irradiation light 90 in the line light source units 25 move in the direction perpendicular to the rotation axis 8.

The line sensor 20 receives light from a portion where the scanning plane 100 and the document 75 or the like cross each other, such that the image of the document 75 in the direction parallel to the rotation axis 8 is read. Meanwhile, when the line sensor 20 rotates around the rotation axis 8 along with the line light source units 25, and the portion where the scanning plane 100 and the document 75 or the like cross each other moves in the direction perpendicular to the rotation axis 8, the line sensor 20 also reads an image in the direction perpendicular to the rotation axis 8.

That is, while the cross portion between the scanning plane 100 and the document 75 or the like is moved in the direction perpendicular to the rotation axis 8, the line sensor 20 reads the image of the document 75 in the cross portion. Thus, it is possible to read an image in the direction parallel to the rotation axis 8 and also to read an image in the direction perpendicular to the rotation axis 8, which is the moving direction of the reading portion. Therefore, the line sensor 20 can read the image of the document 75 in a two-dimensional direction which is the image of the document 75 within the range in both the direction parallel to the rotation axis 8 and the direction perpendicular to the rotation axis 8. The line sensor 20 reads an image within the range of the cross portion between the scanning plane 100 and the document 75 or the like which moves on the document 75.

As described above, when the line sensor 20 is rotated around the rotation axis 8, the distance between the line sensor 20 and the document 75 is changed at every rotation angle. That is, the distance between the line sensor 20 and the document 75 differs depending on the position of the moving cross portion between the scanning plane 100 and the document 75 or the like. For this reason, in reading the image of the document 75 while rotating the rotary head 6 to rotate the line sensor 20, the focus mechanism 38 is activated in accordance with the rotation angle to move the lens 35. The image is read while adjusting the position of the focus with respect to the line sensor 20. Specifically, the distance to the placing surface 70 or the document 75 with respect to the angle of the rotary head 6 can be obtained by calculation in advance, such that the focus mechanism 38 performs focus control in synchronization with the rotation of the motor 50. As described above, when focus control is performed in synchronization with the rotation of the motor 50, the lens 35 is moved at an optimum image distance by the actuator, such as a piezoelectric motor or a voice coil motor, in the focus mechanism 38, to constantly come into focus.

As described above, the rotary head section 5 operates to rotate the line sensor 20 around the rotation axis 8, such that the line sensor 20 reads the image of the document 75. Thus, the range of the cross portion, which moves in accordance with the rotation of the line sensor 20, between the scanning plane 100 and the document 75 or the like becomes the reading region 105 of an image by the line sensor 20 or the overhead image reading apparatus 1 of this embodiment.

Similarly, the rotary head section 5 operates to rotate the line light source units 25 around the rotation axis 8, such that the line light source units 25 moves an irradiation portion in linear irradiation light 90 and irradiates the document 75. The irradiation portion in the linear irradiation light 90, which moves in accordance with the rotation of the line light source units 25, is configured to irradiate the entire reading region 105.

In reading the image of the document 75, the rotary head 6 rotates in the above-described manner, such that the line sensor 20 reads the image of the document 75 within the scanning plane 100. Meanwhile, before the reading of the image of the document 75 starts, the rotary head 6 stops in a state where the cross portion between the scanning plane 100 or linear irradiation light 90 and the document 75 or the like is located around the base 15. In this state, when the reading of the image of the document 75 starts, the rotary head 6 rotates around the rotation axis 8 in the direction in which the cross portion is away from the base 15. When the rotary head 6 rotates at a predetermined angle, the motor 50 starts inverse rotation, and the rotary head 6 rotates in the direction opposite to the previous rotation direction. That is, in this case, the rotary head 6 starts rotation in the direction in which the cross portion between the scanning plane 100 or linear irradiation light 90 and the document 75 or the like approaches the base 15.

Here, with regard to the line sensor 20 and the line light source units 25, when the rotary head 6 rotates and then the scanning plane 100 or linear irradiation light 90 rotates at a predetermined angle in the direction away from the base 15, the reading of the image of the document 75 by the line sensor 20 stops, and the irradiation of the linear irradiation light 90 by the line light source units 25 stops. For this reason, when the rotary head 6 rotates in the direction in which the scanning plane 100 or linear irradiation light 90 approaches the base 15, the rotary head 6 rotates without reading the image of the document 75.

As described above, the rotary head 6 rotates in the direction in which the scanning plane 100 or linear irradiation light 90 approaches the base 15, and the rotation angle of the rotary head 6 becomes the angle before the image of the document 75 is read. When the distance between the cross portion of the scanning plane 100 or linear irradiation light 90 and the document 75 or the like and the base 15 becomes the distance before the image of the document 75 is read, the motor 50 stops and the rotary head 6 stops rotation. That is, the rotary head 6 returns to the state before the image of the document 75 is read. Thus, the overhead image reading apparatus 1 stops operation after the image of the document 75 has been read.

The overhead image reading apparatus 1 reads the image of the document 75 in the above-described manner, and image information of the document 75 read by the line sensor 20 is transmitted to a PC and subjected to appropriate or arbitrary processing, such as shading or cropping, in the PC.

In the above-described overhead image reading apparatus 1, the line sensor 20, which reads the image of the document 75, is provided so as to read the image of the document 75 in the one-dimensional direction. The line light source units 25, which irradiate the document 75 with light, is provided so as to irradiate the linear irradiation light 90 onto the reading region by the line sensor 20. In reading the image of the document 75, the image of the document 75 is read by the line sensor 20 while both the line sensor 20 and the line light source units 25 are rotated as a single body by the rotary head section 5 which holds the line sensor 20 and the line light source units 25. As described above, in reading an image, an image is read while the line sensor 20 is rotated by the rotary head section 5, such that the line sensor 20 which reads an image in the one-dimensional direction can be used as a portion which reads an image. Therefore, it is possible to reduce the size of the portion which reads an image.

The linear irradiation light 90 is irradiated by the collimator lens 28 and the diffuser plate 29, which are provided in the line light source units 25 to convert light from the white LED 26 to linear irradiation light 90. As described above, the linear irradiation light 90 is irradiated by using the collimator lens 28 and the diffuser plate 29, such that linear irradiation light 90 can be irradiated by using a small point-like light source, such as the white LED 26, without using a light source which has a width corresponding to the width of the reading region by the line sensor 20 and irradiates the linear irradiation light 90 with the width of the reading region. As a result, it is possible to reduce the size of the apparatus.

The collimator lens 28 and the diffuser plate 29 are used as a linear light irradiation section. For this reason, after light from the white LED 26 is converted to straight-line light by the collimator lens 28, straight-line light can be converted to the linear irradiation light 90 by the diffuser plate 29. Thus, the linear irradiation light 90 can be irradiated by using the collimator lens 28 and the diffuser plate 29 regardless of the form of the point-like light source, such as the white LED 26. Accordingly, even when a small type of light source is used by putting emphasis on a size, the linear irradiation light 90 can be irradiated regardless of the form of irradiation light. Light emitted from the white LED 26 is converted to straight-line light by the collimator lens 28, such that when linear irradiation light 90 is generated by using the diffuser plate 29, more appropriate linear irradiation light 90 can be generated. Therefore, high-precision linear irradiation light 90 can be irradiated as irradiation light which is irradiated onto the document 75 in reading the image of the document 75, and light which is used in reading an image can be uniformly irradiated onto the reading region by the line sensor 20. As a result, it is possible to more reliably reduce the size of the apparatus and to read an image with stable image quality.

Even when the width of the reading region by the line sensor 20 is large, since the plurality of line light source units 25 is provided, light necessary for reading an image can be irradiated without making the apparatus large-sized. Since the total light quantity distribution 96 of the line light source units 25 is set to a light quantity distribution which supplements the light reception quantity distribution 80 when light is received by the line sensor 20, an image can be read with uniform brightness by the line sensor 20. When light is irradiated by the line light source units 25, it is possible to efficiently distribute light, reducing power consumption. As a result, it is possible to more reliably reduce the size of the apparatus, to suppress power consumption, and to read an image with stable image quality.

The line light source units 25 irradiate the linear irradiation light 90, such that the linear irradiation light 90 includes the optical axis 91 of the collimator lens 28 serving as a straight-line light forming unit. Therefore, the optical axis 91 is directed to a place, at which the quantity of light is needed to increase, in the irradiation range of linear irradiation light 90, easily obtaining a desired light quantity distribution. As a result, it is possible to more easily read an image with stable image quality.

The line light source units 25 irradiate linear irradiation light 90 so that the optical axis 91 is directed to the reading region end portions 106. Because of this, it is possible to increase the quantity of light when light is irradiated from the line light source units 25 around the reading region end portions 106 where the quantity of light received by the line sensor 20 is likely to be small. Therefore, it is possible to more reliably read an image with uniform brightness in reading an image by the line sensor 20 and to read the entire reading region 105 under the same condition. As a result, it is possible to more reliably read an image with stable image quality.

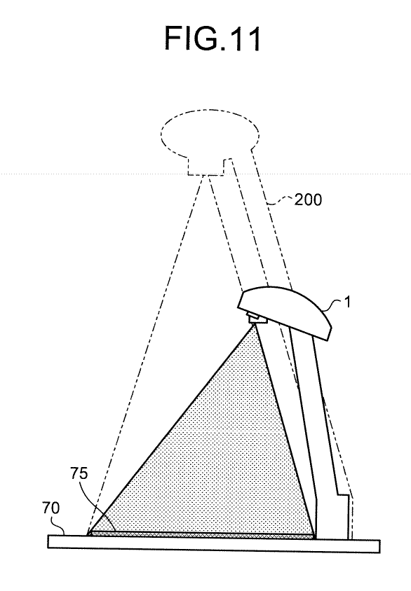

FIG. 11 is a comparison diagram of the overhead image reading apparatus shown in FIG. 1 and an example of an overhead image reading apparatus of the related art. The line sensor 20, which reads an image in the one-dimensional direction, is used as an image reading unit which reads the image of the document 75. The line light source units 25, which irradiate linear irradiation light 90, are used as a light source unit which irradiates the document 75 with light. In reading the image of the document 75, both the line sensor 20 and the line light source units 25 are rotated as one body by the rotary head section 5. Thus, in reading the document 75, as in a related-art image reading apparatus 200 which is an example of an overhead image reading apparatus of the related art, it is not necessary that an image is read from directly above the document 75, and an image can be read obliquely from above the document 75. For this reason, the line sensor 20 or the line light source units 25 can approach the arm 10 which holds the line sensor 20 and the line light source units 25.

The total light quantity distribution 96 of a plurality of line light source units 25 is set to a light quantity distribution which supplements the light reception quantity distribution 80 when light is received by the line sensor 20. Accordingly, even when the line sensor 20 is arranged to approach the document 75, it is possible to read a clear image. That is, when the line sensor 20 approaches the document 75, the light reflected around the end portion of the document 75 has a large angle of incidence when the light is incident on the lens 35. In this case, since the quantity of light which passes through the lens 35 decreases, an image in the relevant portion may be unclear. In contrast, in the overhead image reading apparatus 1 of this embodiment, the quantity of light in the vicinity of the reading region end portions 106 increases, and the quantity of reflected light reflected in the vicinity of the end portion of the document 75 increases, such that reflected light which passes through the lens 35 can have the same quantity over the entire reading region 105. Thus, even when the line sensor 20 is arranged to approach the document 75, reflected light from around the end portion of the document 75 can be received by the line sensor 20 in the same quantity as other portions, by which a clear image can be obtained. Therefore, the line sensor 20 or the line light source units 25 can be arranged at a position lower than in the related-art image reading apparatus 200. As a result, it is possible to more reliably reduce the size of the apparatus and to read an image with stable image quality.

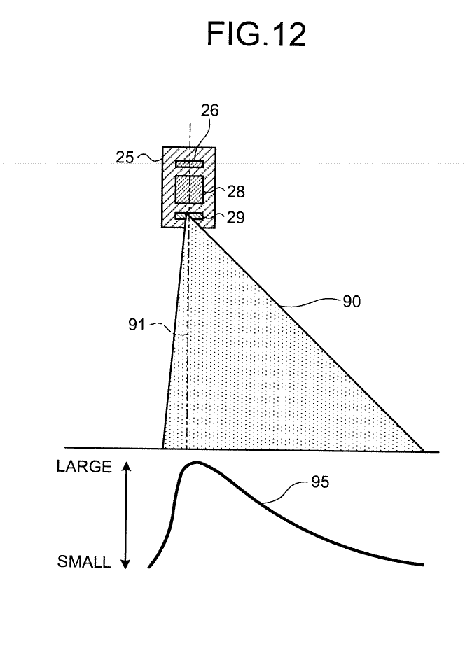

FIG. 12 is an explanatory view illustrating the light quantity distribution of light which is irradiated from line light source units in an overhead image reading apparatus according to a modification. Although in the above-described overhead image reading apparatus 1, the line light source units 25 irradiate linear irradiation light 90 so that light is substantially irradiated uniformly on both sides of the optical axis 91 with the optical axis 91 as a center, the line light source units 25 may be provided to irradiate deflected linear irradiation light 90. For example, as shown in FIG. 12, the line light source units 25 may be provided to irradiate the linear irradiation light 90 such that the irradiation range differs on both sides of the optical axis 91. That is, the diffuser plate 29 serving as a linear light forming section may be provided to convert straight-line light to the deflected linear irradiation light 90.

In this case, the optical axis 91 with the largest quantity of light is in the direction of straight-line light generated by the collimator lens 28 that converts light emitted from the white LED 26. The linear irradiation light 90 is irradiated such that the center in the irradiation range of the linear irradiation light 90 is deviated from the optical axis 91 of the collimator lens 28. That is, the linear irradiation light 90 which is irradiated in a planar shape is different in the width of the irradiation range on both sides of the optical axis 91. As indicated by a light quantity distribution 95 of FIG. 12, the quantity of light is largest in the portion of the optical axis 91 and becomes lower with an increasing distance away from the optical axis 91. Specifically, the linear irradiation light 90 is different in the irradiation range on both sides of the optical axis 91, and with regard to the linear irradiation light 90 in a large irradiation range, the quantity of light gradually decreases with an increasing distance away from the optical axis 91. Meanwhile, with regard to the linear irradiation light 90 in a small irradiation range, the quantity of light rapidly decreases with an increasing distance away from the optical axis 91.

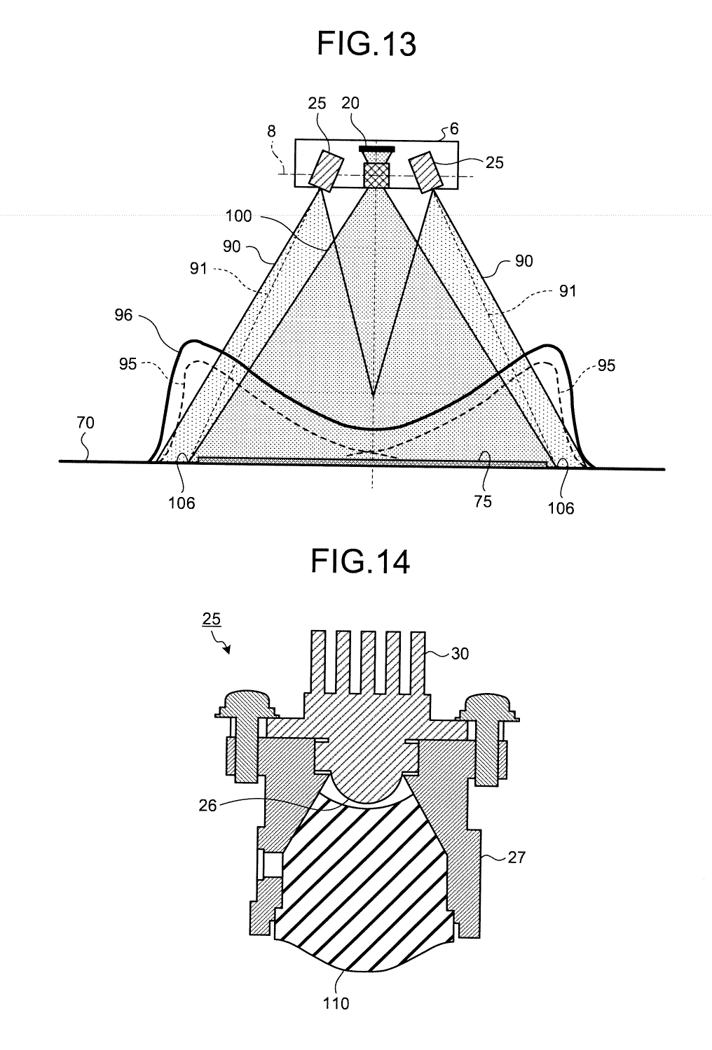

FIG. 13 is an explanatory view illustrating the relationship between linear irradiation light by line light source units and a scanning plane by a line sensor shown in FIG. 12. When the deflected linear irradiation light 90 is irradiated onto the reading region of the image by the line sensor 20, the line light source units 25 irradiate the linear irradiation light 90 so that the optical axis 91 is directed toward the reading region end portion 106 in the direction in which light in a large irradiation range is irradiated inside the scanning plane 100 and light in a small irradiation range is irradiated outside the scanning plane 100. In this case, the plurality of line light source units 25 irradiates linear irradiation light 90 such that the optical axis 91 is directed to the near reading region end portion 106, and the total light quantity distribution 96 is obtained by adding the light quantity distributions 95 of the respective line light source units 25. The linear irradiation light 90 in a small irradiation range is irradiated outside the scanning plane 100, such that irradiation light onto a place where an image is not read is reduced.

As described above, the diffuser plate 29 is provided in the line light source units 25 to convert straight-line light to the deflected linear irradiation light 90. The straight-line light source sections 25 irradiate the deflected linear irradiation light 90 in the direction in which light in a small irradiation range is outside the scanning plane 100 of the line sensor 20, which reduces irradiation of light onto an unnecessary portion. Therefore, it is possible to more reliably and efficiently distribute light. As a result, it is possible to more reliably suppress power consumption and to read an image with stable image quality.

The line light source sections 25 may have a different irradiation range for the linear irradiation light 90. For example, when a plurality of line light source units 25 are provided on each side of the lens 35 through which reflected light from the document 75 passes, as the line light source units 25 which irradiates inside of the scanning plane 100 of the line sensor 20, the line light source units 25 which irradiates linear irradiation light 90 in the substantially uniform irradiation range on both sides of the optical axis 91 are provided to irradiate the linear irradiation light 90. Meanwhile, as the line light source units 25 which irradiate around the reading region end portions 106, the straight-line light source section 25 which irradiates the deflected linear irradiation light 90 is provided to irradiate the linear irradiation light 90 in the direction in which a small irradiation range with the optical axis 91 as a center is outside the scanning plane 100 of the line sensor 20. Therefore, it is possible to irradiate the linear irradiation light 90 in a larger range and to reduce irradiation of light onto an unnecessary portion.

As described above, the line light source units 25, which are different in the irradiation range of the linear irradiation light 90, are provided to irradiate the linear irradiation light 90. Consequently the light quantity distribution of each of the line light source units 25 can be more reliably set to a desired light quantity distribution. As a result, it is possible to more reliably read an image with stable image quality.

In the overhead image reading apparatus 1 of the foregoing embodiment, the adjustment of the focus when an image of the document 75 is read by the line sensor 20 is made through focus control using the focus mechanism 38. However, an image may be read without performing focus control. For example, the depth of field may be extended by a lens in which an aberration is controlled by a phase mask and image processing. This enables an image to be read without performing focus control. A method which extends the depth of field by using a phase mask is described in, for example, U.S. Pat. No. 5,748,371, “Edward R. Dowski, Jr., W. Thomas Cathey, “Extended depth of field through wave-front coding,” Appl. Opt. Vol. 34, 1859-1866 (1995),” or the like.

The method which extends the depth of field using a phase mask will be simply described. The phase mask is arranged between an image reading unit, such as the line sensor 20, and a reading target, such as the document 75, for reading an image. In this case, the control unit 60 is provided with an image processing unit which constructs an image by using an inverse filter for image data read by the image reading unit. In an image reading apparatus which reads the image of the reading target, when an image is read by a typical optical system with no phase mask, the intensity distribution of an optical transfer function is likely to be changed as the position of the reading target is deviated from a focusing position. In contrast, when an image is read by an optical system with a phase mask, even though the position of the reading target is deviated from the focusing position, changes in the intensity distribution of the optical transfer function decrease.

In an optical system with a phase mask, unsharpness of an image is likely to occur compared to a case where no phase mask is provided. Meanwhile, when the reading target is out of focus, since the change in the intensity distribution of the optical transfer function is small, the degree of unsharpness of the image is substantially made uniform. For this reason, if the image processing unit performs image processing based on the inverse filter on image data read by using the phase mask, it is possible to obtain an image with uniform resolution regardless of the degree of out-of-focus and to obtain an image with a small degree of unsharpness due to out-of-focus. Therefore, it is possible to extend the depth of focus, that is, to extend the depth of field.

Thus, with the use of the technique for extending the depth of field, it is not necessary to use a complex structure, such as the focus mechanism 38, which reduces manufacturing cost. Since a large depth can be obtained simultaneously within single scanning, a curved book with a change in depth can be easily read and a clear image can be obtained regardless of the form of a document to be read.

Although the line light source units 25 in the overhead image reading apparatus 1 of the foregoing embodiment use the white LED 26 as a point-like light source, a light source other than the white LED 26 may be used as a point-like light source. Although the collimator lens 28 is used as a straight-line light forming units, and the diffuser plate 29 is used as a linear light forming unit, those other than the collimator lens 28 or the diffuser plate 29 may be used as a straight-line light forming unit or a linear light forming unit. Although a linear light irradiation unit which irradiates the linear irradiation light 90 is constituted by the collimator lens 28 and the diffuser plate 29, a linear light irradiation unit may be constituted by those other than the collimator lens 28 and the diffuser plate 29. For example, a diffraction grating or a cylindrical lens may be used as a linear light irradiation unit.

FIG. 14 is a sectional view of a straight-line light source unit in an overhead image reading apparatus according to a modification. A linear light irradiation unit may be constituted by a single member, instead of using a plurality of members, such as the collimator lens 28 and the diffuser plate 29, as the straight-line light forming unit and the linear light forming unit. For example, as shown in FIG. 14, an aspheric lens 110 may be used. The aspheric lens 110 is made of a transparent material, such as plastic, and is a lens which converts light from a point-like light source, such as the white LED 26, to linear irradiation light 90. Specifically, the aspheric lens 110 is an asymmetric lens in which the curve of a lens surface is designed separately in the longitudinal and lateral directions, that is, in the direction parallel to the rotation axis 8 and the direction perpendicular to the rotation axis 8. If the aspheric lens 110 is used as a linear light irradiation unit, it is possible to directly convert light from a point-like light source to linear irradiation light 90, without converting light to straight-line light before conversion to the linear irradiation light 90. As described above, with regard to the straight-line light source units 25 which are used as a light source unit, any configuration or form may be used insofar as light emitted from a point-like light source can be converted to the linear irradiation light 90 by a linear light irradiation unit.

The overhead image reading apparatus according to the embodiment of the invention has an advantage that it is possible to reduce the size of the apparatus.

According to the first aspect of the invention, the image reading unit which reads the image of the document is provided to read the image of the document in the one-dimensional direction. The light source unit which irradiates the document with light is provided to irradiate linear irradiation light onto the reading region by the image reading unit. In reading the image of the document, the image of the document is read by the image reading unit while the rotary unit section which holds the image reading unit and the light source unit rotates the image reading unit and the light source unit as a single body. Thus, in reading an image, an image is read while the rotary unit section rotates the image reading unit, such that the image reading unit which reads an image in the one-dimensional direction can be used as a unit which reads an image, reducing the size of the unit which reads an image.

Linear irradiation light is irradiated by the linear light irradiation unit which is provided in the light source unit to convert light emitted from the point-like light source to linear irradiation light. Thus, irradiate linear irradiation light is converted using the linear light irradiation unit, such that linear irradiation light can be irradiated by a small light source, without using a light source which has a width corresponding to the width of the reading region by the image reading unit and irradiates linear irradiation light with the width of the reading region. As a result, it is possible to achieve the reduction in size of the apparatus.

According to the second aspect of the invention, the linear light irradiation unit includes the straight-line light forming unit and the linear light forming unit. For this reason, after light from the point-like light source is converted to straight-line light by the straight-line light forming unit, straight-line light can be converted to linear irradiation light by the linear light forming unit. Thus, linear irradiation light can be irradiated using the straight-line light forming unit and the linear light forming unit regardless of the form of the point-like light source, such that, even when a small light source is used focusing on a size, linear irradiation light can be irradiated regardless of the form of irradiation light. Light emitted from the point-like light source is converted to straight-line light by the straight-line light forming unit, such that when linear irradiation light is generated by using the linear light forming unit, it is possible to generate more appropriate linear irradiation light. Therefore, high-precision linear irradiation light can be irradiated as irradiation light which is irradiated onto the document in reading the image of the document, and light which is used in reading an image can be irradiated onto the reading region by the image reading unit with no irregularity. As a result, it is possible to more reliably achieve the reduction in size of the apparatus and to read an image with stable image quality.

According to the third aspect of the invention, even when the width of the reading region by the image reading unit is large, a plurality of light source units are provided, such that light necessary for reading an image can be irradiated without causing an increase in size of the apparatus. The light quantity distribution of the light source units is set to a light quantity distribution which supplements a light reception quantity distribution when light is received by the image reading unit, such that, in reading an image by the image reading unit, an image can be read with uniform brightness. When light is irradiated by the light source units, it is possible to efficiently distribute light, reducing power consumption. As a result, it is possible to more reliably achieve the reduction in size of the apparatus, to suppress power consumption, and to read an image with stable image quality.

According to the fourth aspect of the invention, a plurality of light source units are provided which are different in the irradiation ranges of linear irradiation light, such that the light quantity distribution of the light source unit can be more reliably set to a desired light quantity distribution. As a result, it is possible to more reliably read an image with stable image quality.

According to the fifth aspect of the invention, deflected linear irradiation light is irradiated, such that it is possible to allow light to be not irradiated onto a portion where irradiation is unnecessary, making it possible to more reliably and efficiently distribute light. As a result, it is possible to more reliably suppress power consumption and to read an image with stable image quality.

According to the sixth aspect of the invention, linear irradiation light includes the optical axis of the straight-line light forming unit, such that the optical axis is directed to a place, at which the quantity of light will increase, in the irradiation range of linear irradiation light, easily obtaining a desired light quantity distribution. As a result, it is possible to more easily read an image with stable image quality.

According to the seventh aspect of the invention, light is irradiated such that the optical axis of the straight-line light forming unit is directed to the end portions of the reading region. Thus, it is possible to increase the quantity of light when light is irradiated from the light source unit around the end portions of the reading region where the quantity of light received by the image reading unit is likely to be small. Therefore, it is possible to more reliably read an image with uniform brightness in reading an image by the image reading unit. As a result, it is possible to more reliably read an image with stable image quality.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An overhead image reading apparatus comprising:
an image reading unit which has light receiving elements arranged one-dimensionally to read an image of a document in a one-dimensional direction;
at least one light source unit, which has a point-like light source emitting light and a linear light irradiation unit converting light emitted from the point-like light source to linear irradiation light, and irradiates the linear irradiation light on a reading region of an image by the image reading unit; and
a rotary unit section which holds the image reading unit and the light source unit as a single body and rotates the image reading unit and the light source unit as a single body when the image reading unit reads the image.

2. The overhead image reading apparatus according to claim 1, wherein the linear light irradiation unit includes a straight-line light forming unit which converts light emitted from the point-like light source to straight-line light, and a linear light forming unit which converts the straight-line light to the linear irradiation light.

3. The overhead image reading apparatus according to claim 1, wherein at least one light source unit is two or more in number, and in reading the image of the document, the light source units irradiate the linear irradiation light in such a light quantity distribution as to supplement a light reception quantity distribution when light is received by the image reading section.

4. The overhead image reading apparatus according to claim 3, wherein the light source units have a different irradiation range of the linear irradiation light.

5. The overhead image reading apparatus according to claim 2, wherein the linear light forming unit converts the straight-line light to the linear irradiation light that is deflected.

6. The overhead image reading apparatus according to claim 2, wherein the light source units irradiate the linear irradiation light such that the linear irradiation light includes the optical axis of the straight-line light forming unit.

7. The overhead image reading apparatus according to claim 6, wherein the light source units irradiate the linear irradiation light such that the optical axis of the straight-line light forming unit is directed toward an end portion of the reading region.
